(19) United States
(12) Patent Application Publication
(10) Pub. No.: US 2026/0274489 A1
(43) Pub. Date: Sep. 17, 2026

(54) PACKAGING APPARATUS

(71) Applicant: TAKAZONO CORPORATION, Kadoma-shi, Osaka (JP)

(72) Inventor: Hiroshi Hayashi, Kadoma-shi, Osaka (JP)

(73) Assignee: TAKAZONO CORPORATION, Kadoma-shi, Osaka (JP)

(21) Appl. No.: 19/168,879

(22) PCT Filed: Mar. 4, 2024
(86) PCT No.: PCT/JP2024/008061

§ 371 Date: Sep. 25, 2025

(30) Foreign Application Priority Data
Mar. 29, 2023 (JP) 2023-053352

(51) Int. Cl. B65B 61/02; B41J 2/32; B41J 3/44; B65B 51/26; B65B 61/26

(52) U.S. Cl. CPC B65B 61/025; B41J 2/32; B41J 3/445; B65B 51/26; B65B 61/26

(57) ABSTRACT

Color development occurring in a packaging material having a heat-sensitive color-developing layer during heat sealing of the packaging material is suppressed. The packaging material has a base material and a heat-sensitive color-developing layer stacked on the base material. An accommodation portion forming unit has a heating member and a receiving member disposed to face the heating member. In the packaging material that is being conveyed through the accommodation portion forming unit, the heat-sensitive color-developing layer is positioned farther away from the heating member than the base material.

### TECHNICAL FIELD

The present disclosure relates to a packaging apparatus.

### BACKGROUND ART

Japanese Patent Laying-Open No. 09-188314 (PTL 1) discloses a direct thermal printing and packaging machine configured to use a thermal print head to: cause color development to occur in a color-developing material applied on one surface of packaging paper formed of a first layer and a second layer; make printing on the one surface of the packaging paper; and melt and seal the second layer of the packaging paper with a seal heater to divide the packaging paper into individual packaging bags.

### CITATION LIST

### Patent Literature

PTL 1: Japanese Patent Laying-Open No. 09-188314

### SUMMARY OF INVENTION

### Technical Problem

The above-mentioned literature discloses that the packaging paper is thermally fused at a temperature which is lower than the temperature of the thermal print head and at which color development does not occur by heat in the packaging paper. Since it is required to select the second layer that melts at a temperature lower than the temperature of the color-developing material, the degree of freedom in material selection is low.

The present disclosure proposes a technique that enables suppression of color development occurring in a packaging material having a heat-sensitive color-developing layer when the packaging material is heat-sealed.

### Solution to Problem

A packaging apparatus according to the present disclosure includes: an accommodation portion forming unit that forms an accommodation portion with a packaging material having an elongate sheet shape, the accommodation portion serving to accommodate an object to be packaged; and a printing unit that prints information related to the object to be packaged on the packaging material. The packaging material has a base material, and a heat-sensitive color-developing layer stacked on the base material. The accommodation portion forming unit has a heating member, and a receiving member disposed to face the heating member. The heating member and the receiving member press the packaging material from both sides to form the accommodation portion. In the packaging material that is being conveyed through the accommodation portion forming unit, the heat-sensitive color-developing layer is positioned farther away from the heating member than the base material.

In the above-described packaging apparatus, the base material may have: a first surface on which the heat-sensitive color-developing layer is stacked; and a second surface opposite to the first surface, the packaging material may have a seal layer that melts by being heated by the heating member, the seal layer being stacked on the second surface, and a temperature at which the seal layer melts may be equal to or higher than a temperature at which color development occurs in the heat-sensitive color-developing layer.

In the above-described packaging apparatus, the printing unit may have a thermal head, and, in the packaging material that is being conveyed through the printing unit, the heat-sensitive color-developing layer may be positioned closer to the thermal head than the base material.

### Advantageous Effects of Invention

The packaging apparatus of the present disclosure enables suppression of color development occurring when the packaging material is heat-sealed.

### BRIEF DESCRIPTION OF DRAWINGS

FIG. 1 is a schematic configuration diagram of a packaging apparatus according to an embodiment.

FIG. 2 is a schematic configuration diagram of a printing unit.

FIG. 3 is a schematic configuration diagram of an accommodation portion forming unit.

FIG. 4 is a schematic configuration diagram of an accommodation portion forming unit in a comparative example.

FIG. 5 is a table showing a relation between a temperature applied to a packaging material and color development occurring in a heat-sensitive color-developing layer.

### DESCRIPTION OF EMBODIMENTS

Hereinafter, embodiments will be described with reference to the accompanying drawings. In the following description, the same parts and components are denoted by the same reference characters. Their names and functions are also the same. Therefore, the detailed description thereof will not be repeated. Extraction of any configurations from the embodiment and any combination thereof are also originally intended.

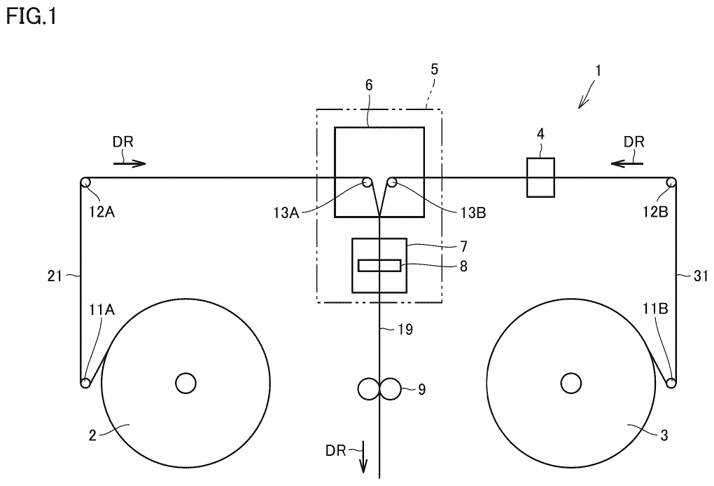

FIG. 1 is a schematic configuration diagram of a packaging apparatus 1 according to an embodiment.

Packaging apparatus 1 is used for packaging an object to be packaged. The object to be packaged is a drug and, specifically, a solid drug. Solid drugs include powder, granules, tablets, pills, capsules, and the like. The object to be packaged is not limited to a solid drug. The object to be packaged may be a semi-solid drug or a liquid drug.

Packaging apparatus 1 is a drug packaging apparatus for packaging drugs based on a prescription. The prescription is issued by a medical doctor to a patient. The prescription describes patient information and drug information. The patient information includes patient's name and age. The drug information includes a drug name, doses, and dosage and administration. Packaging apparatus 1 is used to package drugs for each dosage based on such a prescription.

Packaging material rolls 2 and 3 are attached to packaging apparatus 1. Packaging material roll 2 is formed by winding a packaging material 21 in a roll shape. Packaging material 21 is fed out from packaging material roll 2. Packaging material roll 3 is formed by winding a packaging material 31 in a roll shape. Packaging material 31 is fed out from packaging material roll 3.

In packaging apparatus 1, packaging material 21 unwound from packaging material roll 2 and packaging material 31 unwound from packaging material roll 3 are heat-sealed to be united to form a packaging bag 19 that accommodates a drug. Packaging materials 21 and 31 each have an elongate sheet shape. Packaging apparatus 1 includes a packaging material conveyance unit 9. Packaging material conveyance unit 9 applies driving force to packaging materials 21 and 31 to convey packaging materials 21 and 31. Packaging materials 21 and 31 are conveyed in the long-side direction thereof. Each of arrows in FIG. 1 indicates a conveyance direction DR in which packaging materials 21 and 31 are conveyed.

Guide rollers 11A, 12A, and 13A are provided in this order from the upstream side (the side closer to packaging material roll 2) to the downstream side (the side away from packaging material roll 2) in conveyance direction DR of packaging material 21. Guide rollers 11A, 12A, and 13A each have a function of guiding packaging material 21 that is being conveyed and a function of applying a constant tension to packaging material 21. Guide rollers 11B, 12B, and 13B are provided in this order from the upstream side (the side closer to packaging material roll 3) to the downstream side (the side away from packaging material roll 3) in conveyance direction DR of packaging material 31. Guide rollers 11B, 12B, and 13B each have a function of guiding packaging material 31 that is being conveyed and a function of applying a constant tension to packaging material 31.

Packaging apparatus 1 includes a packaging unit 5. Packaging unit 5 includes a drug supply unit 6, an accommodation portion forming unit 7, and a perforation unit 8.

Drug supply unit 6 supplies a drug between packaging materials 21 and 31 conveyed by packaging material conveyance unit 9. A tip end of a hopper (not shown) is disposed between packaging materials 21 and 31, and then, the drug is introduced into between packaging materials 21 and 31 from the tip end of the hopper. The drug is supplied for each dosage based on a prescription.

Accommodation portion forming unit 7 forms an accommodation portion with packaging materials 21 and 31 conveyed by packaging material conveyance unit 9. The accommodation portion accommodates a drug. After receiving the drug supplied from drug supply unit 6, accommodation portion forming unit 7 thermally fuses packaging materials 21 and 31 to be individually sectioned to form packaging bags 19 each serving as a package containing the drug.

Perforation unit 8 is provided in accommodation portion forming unit 7. Perforation unit 8 provides perforations in packaging materials 21 and 31 that are being conveyed by packaging material conveyance unit 9 such that the perforations extend in the direction orthogonal to conveyance direction DR. The perforations are a plurality of pores continuously arranged in the short-side direction of packaging materials 21 and 31. The perforations are provided in a seal portion to which packaging materials 21 and 31 are thermally fused. The perforations are provided at positions at which packaging bags 19 adjacent to each other in the long-side direction of packaging materials 21 and 31 are divided. By splitting packaging materials 21 and 31 along the perforations, packaging bags 19 adjacent to each other are easily separated from each other.

Packaging apparatus 1 further includes a printing unit 4. Printing unit 4 prints prescribed information on packaging material 31 that is unwound from packaging material roll 3 and conveyed by packaging material conveyance unit 9. The prescribed information is related to drugs. Printing unit 4 is disposed upstream of packaging unit 5 in the conveyance direction of packaging material 31. Printing unit 4 prints the information related to drugs on packaging material 31 before packaging materials 21 and 31 are thermally fused by accommodation portion forming unit 7. The information related to the drugs includes a patient name, dosage time, a drug name, the number and amount of drugs, and the like.

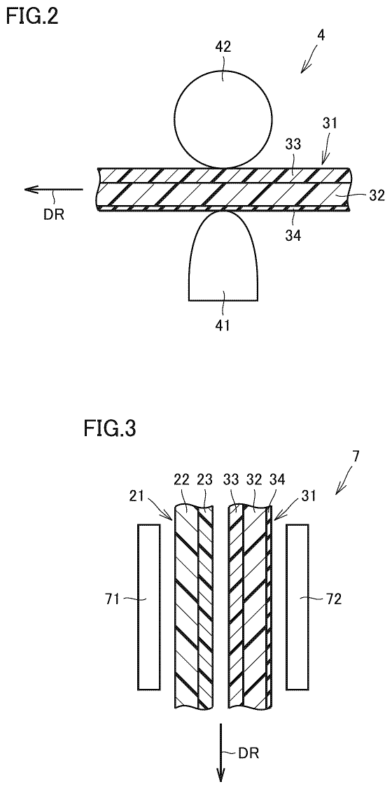

FIG. 2 is a schematic configuration diagram of printing unit 4. As shown in FIG. 2, packaging material 31 includes a base material 32, a seal layer 33, and a heat-sensitive color-developing layer 34. Base material 32 has a first surface and a second surface opposite to the first surface. Heat-sensitive color-developing layer 34 is stacked on the first surface of base material 32. Seal layer 33 is stacked on the second surface of base material 32. Packaging material 31 has a stacking structure in which seal layer 33, base material 32, and heat-sensitive color-developing layer 34 are stacked in this order.

Base material 32 is made of paper, for example. Base material 32 may be made of glassine paper. The glassine paper may have a thickness of 30 g/m² . Base material 32 may be made of a film. Base material 32 may be made of polyethylene terephthalate (PET). The film may have a thickness of 25 μm. Seal layer 33 is made of a low-melting-point material such as polyethylene. Seal layer 33 may have a thickness of 15 μm. Seal layer 33 may be thicker or thinner than base material 32. Heat-sensitive color-developing layer 34 may be made of a material that causes color development to occur at a temperature higher than the temperature at which seal layer 33 melts. Heat-sensitive color-developing layer 34 may be formed by applying a heat-sensitive material onto the first surface of base material 32.

Packaging material 31 is not limited to the above-mentioned examples but may be heat-sensitive paper. Color development occurs in the heat-sensitive paper when this heat-sensitive paper is heated to about 80° C. to 90° C. Thus, in the case of heat-sensitive paper, the temperature at which seal layer 33 melts is equal to or higher than the temperature at which color development occurs in heat-sensitive color-developing layer 34.

Printing unit 4 includes a thermal head 41 and a platen roller 42. Thermal head 41 includes a heat generating element. Platen roller 42 supports packaging material 31. Thermal head 41 and platen roller 42 are disposed to face each other with packaging material 31 being interposed therebetween.

Printing unit 4 heats heat-sensitive color-developing layer 34 of packaging material 31 with thermal head 41 serving as a printing head, to thereby cause color development to occur in heat-sensitive color-developing layer 34. Thermal head 41 is pressed into contact with platen roller 42 with packaging material 31 being interposed therebetween. Then, by causing the heat generating element of thermal head 41 to generate heat in this state, prescribed information related to the drug as an object to be packaged is printed on packaging material 31 for each package.

In packaging material 31 that is being conveyed through printing unit 4, heat-sensitive color-developing layer 34 is positioned closer to thermal head 41 than base material 32.

FIG. 3 is a schematic configuration diagram of accommodation portion forming unit 7. FIG. 3 does not show perforation unit 8. As shown in FIG. 3, packaging material 21 includes a base material 22 and a seal layer 23. Packaging material 21 has a stacking structure in which base material 22 and seal layer 23 are stacked. Packaging material 21 does not have a heat-sensitive color-developing layer. Even when packaging material 21 is heated, color development does not occur therein.

Base material 22 may be made, for example, of biaxially oriented polypropylene (OPP). Base material 22 may have a thickness of 25 μm. Seal layer 23 may be made of polyethylene, for example. Seal layer 23 may have a thickness of 15 μm.

Accommodation portion forming unit 7 includes a heating member 71 and a receiving member 72. Heating member 71 has a built-in heater and is heated by the heater. Receiving member 72 serves to receive heating member 71. Receiving member 72 is not configured to generate heat and basically remains at room temperature. Heating member 71 and receiving member 72 are disposed to face each other such that packaging materials 21 and 31 are interposed therebetween.

Heating member 71 may be formed, for example, by applying electroless nickel-phosphorus-polytetrafluoroethylene (PTFE) (fluorine resin) composite plating to aluminum. Receiving member 72 may be formed, for example, by baking a fluorine fiber sheet onto silicone rubber having a hardness of 30 degrees.

In the state in which heating member 71 is heated by the heater, heating member 71 and receiving member 72 are driven by a driving source (not shown) to pressurize packaging materials 21 and 31 from both sides, so that seal layer 23 of packaging material 21 and seal layer 33 of packaging material 31 are thermally fused to form an accommodation portion. The drug is accommodated in the accommodation portion. Accommodation portion forming unit 7 packages drugs, i.e., objects to be packaged, one by one.

In packaging materials 21 and 31 that are being conveyed through accommodation portion forming unit 7, packaging material 21 is positioned close to heating member 71 and packaging material 31 is positioned close to receiving member 72. Seal layer 23 of packaging material 21 and seal layer 33 of packaging material 31 face each other. Seal layers 23 and 33 on the inner sides of respective packaging materials 21 and 31 overlap with each other. When seal layers 23 and 33 are melted by the heat received from heating member 71, seal layers 23 and 33 are thermally fused to form an accommodation portion.

In packaging material 31, seal layer 33 is positioned closer to heating member 71 than base material 32 and positioned closest to heating member 71. In packaging material 31, heat-sensitive color-developing layer 34 is positioned farther away from heating member 71 than base material 32, and positioned farthest away from heating member 71. Heat-sensitive color-developing layer 34 faces receiving member 72.

Heat-sensitive color-developing layer 34 is located at a position to which the heat generated by the heater of heating member 71 is most unlikely to be conducted. The amount of heat transmitted from heating member 71 to heat-sensitive color-developing layer 34 is smaller than the amount of heat transmitted from heating member 71 to seal layers 23 and 33.

Thermal head 41 of printing unit 4 may be heated to a temperature higher than the temperature of heating member 71 of accommodation portion forming unit 7. Thermal head 41 may be a heat source that is higher in temperature than the heater of heating member 71. The heat higher in temperature than heating member 71 may be transmitted from thermal head 41 to heat-sensitive color-developing layer 34. Even when thermal head 41 is heated to a temperature higher than that of heating member 71, seal layer 33 of packaging material 31 is not pressurized while packaging material 31 passes through printing unit 4, and also, the time during which packaging material 31 passes through printing unit 4 is short, with the result that melting of seal layer 33 in printing unit 4 is suppressed.

In packaging apparatus 1 of the embodiment described above, packaging material 31 includes base material 32 and heat-sensitive color-developing layer 34 stacked on base material 32, as shown in FIG. 3. Accommodation portion forming unit 7 includes heating member 71 and receiving member 72 disposed to face heating member 71. In packaging material 31 that is being conveyed through accommodation portion forming unit 7, heat-sensitive color-developing layer 34 is positioned farther away from heating member 71 than base material 32.

Since packaging material 31 has heat-sensitive color-developing layer 34 and color development is caused to occur in heat-sensitive color-developing layer 34 to thereby print prescribed information related to the drug on packaging material 31, printing can be made on packaging material 31 without using any ink ribbon. Thereby, printing unit 4 can be reduced in size. The operation for loading an ink ribbon into packaging apparatus 1 can be omitted. Used ink ribbons do not occur, which eliminates the operation for collecting such used ink ribbons and also eliminates the need to manage the personal information remaining on the ink ribbon.

In accommodation portion forming unit 7, heat-sensitive color-developing layer 34 is positioned away from heating member 71, which implements a mechanism in which, during heat sealing for thermally fusing seal layers 23 and 33, the amount of heat necessary for causing color development is not transmitted to heat-sensitive color-developing layer 34, so that color development does not occur in heat-sensitive color-developing layer 34. Thereby, it is possible to suppress color development occurring in heat-sensitive color-developing layer 34 when packaging material 31 having heat-sensitive color-developing layer 34 is heat-sealed. Since any seal layer can be used without being limited to seal layer 33 that melts at a temperature lower than the temperature at which color development occurs in heat-sensitive color-developing layer 34, the degree of freedom in material selection can be improved.

As shown in FIG. 3, packaging material 31 may have seal layer 33, and the temperature at which seal layer 33 melts may be equal to or higher than the temperature at which color development occurs in heat-sensitive color-developing layer 34. In this case, even if packaging material 31 is heated in accommodation portion forming unit 7 to a temperature at which seal layer 33 can be melted, the amount of heat necessary for causing color development is not transmitted to heat-sensitive color-developing layer 34 because heat-sensitive color-developing layer 34 is positioned away from heating member 71. Therefore, color development in heat-sensitive color-developing layer 34 can be suppressed.

As shown in FIG. 2, in packaging material 31 that is being conveyed through printing unit 4, heat-sensitive color-developing layer 34 may be positioned closer to thermal head 41 than base material 32. In this way, heat can be efficiently transmitted from thermal head 41 to heat-sensitive color-developing layer 34, to thereby allow color development to reliably occur in heat-sensitive color-developing layer 34 in printing unit 4, so that necessary information can be printed on packaging material 31.

Thermal head 41 may be heated to a temperature higher than that of heating member 71. Increasing the amount of heat transmitted to heat-sensitive color-developing layer 34 in printing unit 4 allows color development to reliably occur in heat-sensitive color-developing layer 34.

In the example as described above, flat packaging materials 21 and 31 unwound from two packaging material rolls 2 and 3 are heat-sealed to form packaging bags 19, but the present disclosure is not limited thereto. A packaging material folded in two may be heat-sealed to form packaging bags 19. In this case, a packaging material folded in two in advance may be wound in a roll shape to form a packaging material roll, from which a packaging material folded in two may be fed out. Alternatively, a mechanism for folding a packaging material in two may be provided between the packaging material roll and packaging unit 5, and the packaging material fed out from the packaging material roll may be folded in two on the upstream side of packaging unit 5.

In the case where a packaging material folded in two is used, a heat-sensitive color-developing layer is formed on a half section of an elongate sheet-shaped packaging material in its short-side direction (the width direction) before this packaging material is folded in two. This packaging material is folded in two, and, in accommodation portion forming unit 7, a heat-sensitive color-developing layer is located at a position farthest away from heating member 71 as in FIG. 3. Thereby, it is possible to similarly achieve an effect of enabling suppression of color development occurring in the heat-sensitive color-developing layer during heat sealing.

Receiving member 72 may remain at an ambient temperature under no temperature control, but may be controlled to be cooled. Receiving member 72 may be cooled by any method. Receiving member 72 may be cooled by exchange of heat with a cooling medium, for example, by a water-cooling method, an air-cooling method or the like. Alternatively, receiving member 72 may be provided with any temperature adjustment device that cools receiving member 72, such as a Peltier element to which a current is applied for transferring heat.

### EXAMPLES

Hereinafter, examples will be described. Experiments were conducted to check color development occurring in each of packaging materials in an example and a comparative example that were heated and pressurized between heating member 71 and receiving member 72. In the example, packaging materials 21 and 31 were positioned between heating member 71 and receiving member 72 as shown in FIG. 3.

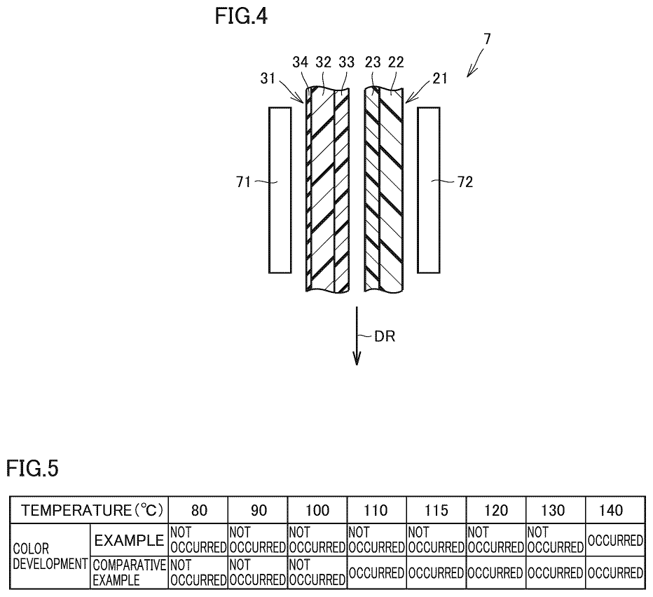

FIG. 4 is a schematic configuration diagram of accommodation portion forming unit 7 in the comparative example. In the comparative example, packaging materials 21 and 31 were positioned between heating member 71 and receiving member 72 as shown in FIG. 4. As shown in FIG. 4, in the comparative example, packaging material 31 was positioned close to heating member 71, and packaging material 21 was positioned close to receiving member 72, in contrast to the example. In packaging material 31 in the comparative example, heat-sensitive color-developing layer 34 was positioned closer to heating member 71 than base material 32, positioned closest to heating member 71, and positioned to face heating member 71. In other words, in the comparative example, heat-sensitive color-developing layer 34 was located at a position to which the heat generated by the heater of heating member 71 was most likely to be conducted.

FIG. 5 is a table showing the relation between the temperature applied to packaging material 31 and the color development occurring in heat-sensitive color-developing layer 34 in the example and the comparative example. FIG. 5 summarizes whether or not color development occurred in heat-sensitive color-developing layer 34 when heating member 71 was heated to 80° C. to 140° C.

As shown in FIG. 5, in the comparative example, color development occurred in heat-sensitive color-developing layer 34 when heating member 71 was heated to 110° C. or more. On the other hand, in the example, color development did not occur in heat-sensitive color-developing layer 34 even when heating member 71 was heated to 130° C., but color development occurred in heat-sensitive color-developing layer 34 when heating member 71 was heated to 140° C.

When seal layers 23 and 33 are made of polyethylene, seal layers 23 and 33 start to melt under a temperature load of about 110° C. Thus, the temperature of heating member 71 in accommodation portion forming unit 7 can be set, for example, at about 125° C. In the comparative example, color development occurs in heat-sensitive color-developing layer 34 when heating member 71 is heated to 125° C. On the other hand, in the example, color development does not occur in heat-sensitive color-developing layer 34 even when heating member 71 is heated to 125° C. In the example, it is possible to satisfy a condition under which seal layers 23 and 33 can be thermally fused without causing color development to occur in heat-sensitive color-developing layer 34 when the packaging material is heat-sealed.

Therefore, it was shown that color development occurring during heat sealing of packaging materials 21 and 31 can be suppressed by positioning heat-sensitive color-developing layer 34 to be away from heating member 71 as in the example, in an arrangement in which packaging materials 21 and 31 are positioned between heating member 71 and receiving member 72.

Although the embodiments of the present invention have been described as above, it should be understood that the embodiments disclosed herein are illustrative and non-restrictive in every respect. The scope of the present invention is defined by the terms of the claims rather than the description above, and is intended to include any modifications within the scope and meaning equivalent to the terms of the claims.

### REFERENCE SIGNS LIST

1 packaging apparatus, 2, 3 packaging material roll, 4 printing unit, 5 packaging unit, 6 drug supply unit, 7 accommodation portion forming unit, 8 perforation unit, 9 packaging material conveyance unit, 11A, 11B, 12A, 12B, 13A, 13B guide roller, 19 packaging bag, 21, 31 packaging material, 22, 32 base material, 23, 33 seal layer, 34 heat-sensitive color-developing layer, 41 thermal head, 42 platen roller, 71 heating member, 72 receiving member, DR conveyance direction.

1. A packaging apparatus comprising:
an accommodation portion forming unit that forms an accommodation portion with a packaging material having an elongate sheet shape, the accommodation portion serving to accommodate an object to be packaged; and
a printing unit that prints information related to the object to be packaged on the packaging material, wherein
the packaging material has
a base material, and
a heat-sensitive color-developing layer stacked on the base material,
the accommodation portion forming unit has
a heating member, and
a receiving member disposed to face the heating member,
the heating member and the receiving member press the packaging material from both sides to form the accommodation portion, and
in the packaging material that is being conveyed through the accommodation portion forming unit, the heat-sensitive color-developing layer is positioned farther away from the heating member than the base material.

2. The packaging apparatus according to claim 1, wherein
the base material has
a first surface on which the heat-sensitive color-developing layer is stacked, and
a second surface opposite to the first surface, the packaging material has a seal layer that melts by being heated by the heating member,
the seal layer being stacked on the second surface, and
a temperature at which the seal layer melts is equal to or higher than a temperature at which color development occurs in the heat-sensitive color-developing layer.

3. The packaging apparatus according to claim 1, wherein
the printing unit has a thermal head, and
in the packaging material that is being conveyed through the printing unit, the heat-sensitive color-developing layer is positioned closer to the thermal head than the base material.
